(19) United States
(12) Patent Application Publication
(10) Pub. No.: US 2022/0151314 A1
(43) Pub. Date: May 19, 2022

(54) SMART MULTIPURPOSE ANTI-COLLISION SUIT AND SKI RESORT SAFETY SYSTEM

(71) Applicant: Yingui SUN, Beijing (CN)

(72) Inventors: Yingui SUN, Beijing (CN); Jianping ZHANG, Beijing (CN); Hui Elizabeth ZHOU, Beijing (CN); Sai ZHANG, Beijing (CN); Shiguo WANG, Beijing (CN); Lei WANG, Beijing (CN)

(21) Appl. No.: 17/598,599

(22) PCT Filed: Mar. 27, 2020
(86) PCT No.: PCT/CN2020/081725

§ 371 Date: Sep. 27, 2021

(30) Foreign Application Priority Data
Mar. 29, 2019 (CN) 201920417524.9
Jan. 8, 2020 (CN) 202010017323.7

(51) Int. Cl. A41D 13/015; G08B 25/00; A63B 69/18

(52) U.S. Cl. CPC A41D 13/0155; A63B 69/18; G08B 25/009

(57) ABSTRACT

A ski resort safety system and method. A ski resort comprises a piste (300). The ski resort safety system comprises: an anti-collision suit (1), wherein the anti-collision suit (1) is worn by a skier and comprises an inflation device (100) and a control device (200), the inflation device (100) is configured to inflate the anti-collision suit (1) under the control of the control device (200), and the control device (200) is configured to detect the condition of the skier, and when the skier encounters a danger, trigger the inflation device (100) to inflate the anti-collision suit (1), and is configured to transmit a danger signal when detecting the dangerous condition of the skier; and relay devices (301), wherein the relay devices (301) are arranged along the piste (300) at a certain interval so as to receive the danger signal, and transmit a trigger signal to other skiers (2′) on the piste (300). By triggering the anti-collision suits (1) of other skiers (2′) located below an out-of-control skier (2), the out-of-control skier (2) per se can be protected, and other skiers (2′) are also effectively prevented from being accidently damaged.

This application claims the priority of Chinese utility model patent application 201920417524.9 with a title of “Smart Multi-purpose Protective Suit” filed on Mar. 29, 2019 and Chinese invention patent application with a title of “Ski Resort Safety System” 202010017323.7 filed on Jan. 8, 2020, the contents of each of which are hereby incorporated by reference in their entirety.

### TECHNICAL FIELD

The present disclosure relates to a smart multi-purpose anti-collision suit and a ski resort safety system.

### BACKGROUND

Skiing, driving motorcycles, racing cars, and high-altitude operations are inherently dangerous due to the speed and altitude. In order to prevent or at least reduce the damage to the person caused by high-speed collision or high-altitude fall, the applicant provides a protective suit that can quickly adjust the air pressure therein in its previous applications PCT/CN2017/105381 and CN201920417524.9, which are incorporated herein by reference.

This kind of protective suit can effectively protect the personal safety of the skier by instant inflation. However, investigations have found that 80% of the casualties in ski resorts were caused by others (beginners or people who are out of control causing harm to the innocent people below them from behind). Therefore, it is not only necessary to protect the out-of-control skiers themselves, but also to protect the skiers in their vicinity, especially the skiers below them.

### SUMMARY

The present invention utilizes the “anti-collision suit” that the Inventor previously invented to perform system management and coordination. A worry-free environment for entertainment and exercise is created in the ski resort without reducing stimulation, realizing a recreational sports venue that can greatly improve safety.

The invention is realized in such a way that when the skier perceives the danger or the sensor detects the danger, the “anti-collision suit” will start to inflate under the active and passive conditions (the skier throws away the ski pole on his own, or the sensor detects the danger). At this time, the “anti-collision suit” inflates at the same time it will transmit the signal to the signal relay devices installed on both sides of the ski trail. The relay devices will timely transmit the signal to other skiers wearing “anti-collision suits” nearby to trigger the inflation of their anti-collision suits so as to deal with the danger of impending impact. In order to create a safe and full coverage effectively, each skier entering the ski resort must wear an “anti-collision suit” that can be matched by the linkage signal.

According to the present invention, a safety system of a ski resort is provide, the ski resort including a ski trail, and the safety system comprising: a detection device, which detects a skier on the ski trail, and receives a danger signal issued by the skier's anti-collision suit when the skier is in a dangerous situation, wherein the danger signal contains geographic location information representing the location of the skier; and a safety controller, the safety device transmitting a danger trigger signal according to the danger signal, so that the inflating devices of the anti-collision suit of other skiers in a dangerous area at a predetermined distance from the skier are triggered, in order to inflate the anti-collision suit.

The detection device includes relay devices which are arranged at a certain interval along the ski trail, wherein the relay devices receive the danger signal and forward it as a danger trigger signal. The danger trigger signal includes geographic location information of the skier.

The skier's anti-collision suit includes a controller that receives data sensed by a sensing mechanism, and the sensing mechanism includes a geographic location sensor configured to sense the geographic location information of the skier.

The sensing mechanism also includes one or more of the following sensors: a speed and/or acceleration sensor, wherein the acceleration sensor may sense the speed and/or acceleration of the skier; a tilt sensor, such as a gyroscope or a magnetic sensor, which may sense the skier's body posture; a physiological sensor, which may sense the physiological signs of the skier wearing the anti-collision suit, such as blood pressure, heart rate and body temperature; a proximity sensor, to sense the distance between the skier and surrounding obstacles or other skiers nearby; and an image sensor to image the scene around the skier.

The controller also receives information to determine whether the ski poles are held by the skier. In the case of snowboarding, similar to skiing, the skier may hold a trigger element, for example, a handle similar to a ski pole, and the controller receives information that confirms that the skier holds the trigger element.

Said dangerous situation may optionally include one or more of the following: the distance between the skier and the surrounding obstacles is less than a predetermined threshold, the heartbeat or body temperature of the skier is outside the normal range, and the skier falls and does not return to the normal state from the fallen state within a predetermined time.

The dangerous condition may also optionally include the detachment of the ski pole from the skier, or in the case of snowboarding, the detachment of the trigger element from the skier.

The danger signal and the danger trigger signal preferably adopt different coding formats.

The controller is configured to compare the position information contained in the trigger signal with its own position information sensed by the sensing mechanism to determine whether it is located in the dangerous area, and triggers the inflating device to inflate the anti-collision suit when it is in the dangerous area.

The predetermined distance may vary according to the location of the skier or the speed and/or acceleration of the skier.

The detection device includes positioning base stations, each of which covers a predetermined area of a ski resort, and receives position information signal sent by a skier's anti-collision suit located in the predetermined area to determine the location information and motion status information of the skier;

The safety controller determines the dangerous area according to the position information and the motion state information of the skier who sent the danger signal, and makes the positioning base station covering the dangerous area transmit the dangerous trigger signal; and

controllers of the anti-collision suits of the skiers located in the dangerous area receives the trigger signal and triggers the inflating device to inflate the anti-collision suits.

The ski resort security system also includes a prohibition signal transmitting station, which is arranged at a location where the anti-collision suit is not expected to be triggered, so as to prevent the anti-collision suit from being triggered at that location.

The present invention also provides a method to ensure the safety of skiers, including: receiving a danger signal sent by a first skier in a dangerous or out-of-control state; and making the anti-collision suit of a second skier in a dangerous area at a predetermined distance from the first skier be inflated

The danger signal includes position information representing the geographic location of the first skier; and the predetermined distance is determined according to the position information and/or the speed/acceleration information of the first skier.

Preferably, the receiving step comprises using a relay device near the ski trail to receive the danger signal; and wherein the making step includes the relay device sending out a danger trigger signal in a format different from the danger signal, the danger trigger signal containing the position information of the first skier and/or the speed/acceleration information of the first skier.

The making step includes the controller of the second skier's anti-collision suit receiving the danger trigger information, calculating the dangerous area based on the position information and/or speed/acceleration information contained in the danger trigger information, and determining whether the second skier is in the dangerous area according to the information representing the geographic position of the second skier.

As another embodiment, the method further comprises a positioning step in which a plurality of positioning base stations distributed in the ski resort receive positioning signals of the first skier to determine the position and motion status of the first skier, wherein the plurality of positioning base stations are distributed to cover different predetermined areas of the ski resort.

The making step includes a safety controller in communication with a positioning base station receiving the danger signal, and calculating a dangerous area according to the danger signal, the position and the motion status information of the first skier, and prompting the positioning base station covering the dangerous area to send a danger trigger signal.

The dangerous or out-of-control state is determined by detecting the detachment of ski poles from the skier.

Thanks to the present invention, by triggering the anti-collision suit of the skier below the out-of-control skier, accidental injuries caused by the out-of-control skier to other skiers can be avoided. In addition, because the anti-collision suits are absolutely prevented from linkages with each other, linkage can be made possible through the relay devices. The relay devices can prevent unnecessary misoperation and range by effectively screening the signals through coverage direction, signal distance and intelligent judgment. For example, when queuing in the ropeway and dining together, any individual wearing the “anti-collision suit”, whether there is a misoperation or testing, will not cause panic and trouble to other “anti-collision suit” wearers.

### BRIEF DESCRIPTION OF THE DRAWINGS

The above and other features, advantages and technical superiority can be understood in light of the detailed description of preferred embodiments of the invention with reference to the drawings, in which:

FIGS. 1A and 1B are front and rear views showing the smart anti-collision suit;

FIG. 2 is an exploded perspective view of the inflating device;

FIG. 3 is a top view of the inflating device 100;

FIG. 4 is a bottom view of the inflating device 100;

FIG. 5 is a cross-sectional view along B-B of FIG. 3;

FIG. 6 is a cross-sectional view along C-C of FIG. 3;

FIG. 7 is an enlarged view of the circle in FIG. 5;

FIG. 8 is a schematic block diagram showing the control device of the anti-collision suit 1;

FIG. 9 is a schematic diagram showing an embodiment of a ski resort safety system; and

FIG. 10 is a schematic diagram showing another embodiment of the ski resort safety system.

### DETAILED DESCRIPTION

Reference will now be made in detail to the embodiments, examples of which are shown in the drawings, in which similar reference numerals always refer to similar elements. In this regard, the present embodiments may have different forms, and should not be construed as being limited to the description set forth here. Therefore, the embodiments are described below simply by referring to the figures to explain various aspects of the disclosure. As used herein, the term “and/or” includes any and all combinations of one or more of the associated listed items. When expressions such as “at least one of” precede an element list, they are used to modify the entire element list, instead of modifying each element of the list.

Hereinafter, the embodiments will be explained with reference to the drawings.

The embodiments of the present disclosure are provided to enable those of ordinary skill in the art to fully understand the present disclosure. However, the embodiments may be embodied in many different forms, and the scope of the present disclosure should not be construed as being limited to the embodiments set forth herein. Rather, these embodiments are provided so that the present disclosure will be thorough and complete, and will fully convey the concept of the present disclosure to those of ordinary skill in the art.

The terms used herein are only for the purpose of describing specific embodiments and are not intended to limit the present disclosure. As used herein, the singular forms “a” and “the” are intended to include the plural forms as well, unless the context clearly dictates otherwise. It will also be understood that when the term “comprising” is used in the present disclosure, it specifies the presence of the described features, integers, steps, operations, elements, components, and/or groups thereof, but does not exclude the presence or addition of one or more of other features, integers, steps, operations, elements, components, and/or groups thereof. As used herein, the term “and/or” includes any and all combinations of one or more of the associated listed items.

It will be understood that although the terms “first”, “second”, etc. may be used herein to describe various members, regions, layers, portions and/or components, these members, regions, layers, portions and/or components should not be subject to the restrictions of these terms. These components do not indicate a specific order or superiority, but are only used to distinguish one component, region, layer, portion or component from another. Therefore, a first member, region, portion, or component may indicate a second member, region, portion or component.

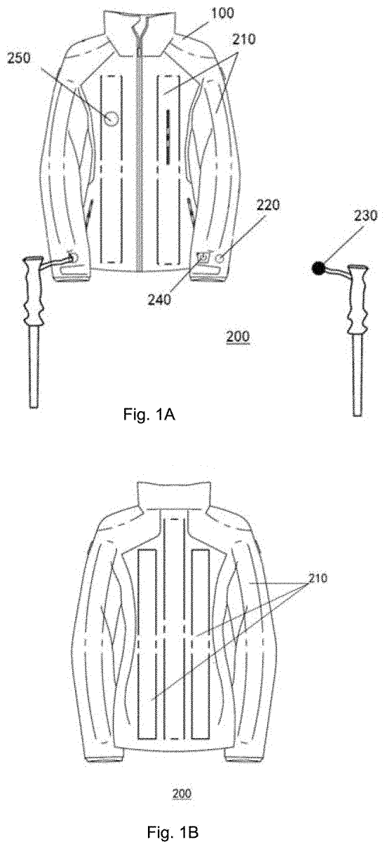

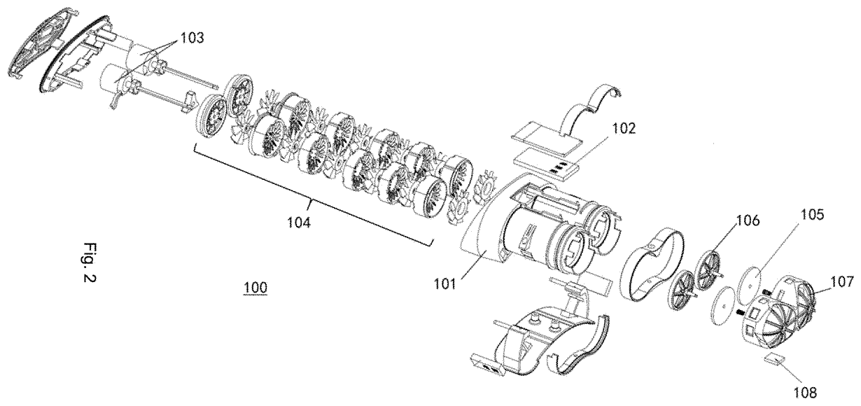

Hereinafter, referring to FIG. 1A to FIG. 7, the anti-collision suit 1 according to an embodiment of the present disclosure will be described. FIGS. 1A and 1B are front and rear views showing the smart anti-collision suit. As shown in FIGS. 1A and 1B, the appearance of the anti-collision suit is similar to that of ordinary anti-collision suits, including a front flap, a back flap, left and right shoulders, left and right sleeves and a collar.

However, in the anti-collision suit 1 according to the present disclosure, a plurality of airbags 210 are provided, for example, in the front and back flap, the left and right sleeves, and the collar. And left and right inflating device 100 are respectively provided at the left and right shoulders. The plurality of airbags arranged in the anti-collision suit can be inflated by the left and right inflating devices when it is sensed that a danger is about to happen or happening, thereby providing cushioning protection for skiers, especially for the key parts of skiers. These parts for example include the chest, the spine, left and right elbows, neck and so on.

These airbags can be communicated in series with each other, so that the left and right inflating devices inflate all the airbags in sequence. Alternatively, these airbags can be divided into a plurality of groups. The airbags in each group are communicated in series, and the groups are communicated in parallel, with each group being communicated with the left and/or right inflating device through tubes, so as to inflate the airbags in a predetermined sequence. Preferably, the airbag groups for protecting the neck and the spine are inflated first, then the airbags for protecting the chest is inflated, and finally the airbags for protecting the elbows is inflated.

A sensing element 220 is provided at a predetermined position of the anti-collision suit, for example, at the locations on the left and/or right sleeves adjacent to the cuffs. The sensing element can sense the presence of a trigger element 230, and send out a trigger signal when the trigger element 230 cannot be sensed, thereby triggering the inflating devices.

In a preferred embodiment, the sensing element is a Hall element, and the trigger element is a magnetic sheet. The trigger element is connected to a ski pole for example by a tether. Therefore under normal conditions, for example, when the skier is skiing safely, the skier holds the ski poles, and the magnetic sheet is attracted to the Hall element by virtue of its magnetism, so that the Hall element can sense the magnetism of the magnetic sheet. When a dangerous situation occurs, for example, when the skier falls, the ski poles are detached from the skier's hands, causing the magnetic sheet to separate from the Hall element. In this situation, the Hall element cannot sense the magnetism of the magnetic sheet, and then sends out a trigger signal. Upon the receipt of the trigger signal by the inflating device, the inflating device starts to inflate the airbags in the anti-collision suit. The trigger signal sent by the Hall element can be transmitted in a wireless or wired manner, and received by the controller of the inflating device in a wired or wireless manner.

As another embodiment, the sensing element may be a reed switch. When the magnetic sheet is attracted to the reed switch, the switch is closed, and when the magnetic sheet is disengaged, the reed switch is open. Thus, the signal that the magnetic sheet is disengaged is received by the inflating device to trigger the inflating device. Alternatively, the reed switch may be open when the magnetic sheet is attracted to the reed switch, and the reed switch may be closed by virtue of its own elasticity when the magnetic sheet is disengaged for example because the skier falls, thereby triggering the inflating device.

As yet another embodiment, the sensing element may be a photoelectric element, which is embedded in the cuffs of the left and/or right sleeves. The cuffs are provided with a hole where the photoelectric element is provided. When the magnetic sheet is attracted to the sleeve, the hole is blocked, and when the magnetic sheet is disengaged, the hole is exposed so that the photoelectric element senses light through the hole, and then generates a trigger signal to trigger the inflating device.

The above shows various examples of sensing elements. However, those skilled in the art can understand that the present invention is not limited to these examples, but can use any kind of sensing element. In addition, the above trigger element is described by example of a magnetic sheet. However, the trigger element may also be other elements. For example, the trigger element may be any element that is releasably attached to the sleeve through other means such as velcro, snaps, etc.

In addition, although the trigger element is attached to the sleeve to be sensed by the sensing element as mentioned above, it should be understood that according to the present invention, the trigger element does not have to be attached to the sleeve to achieve the goal of the present invention, as long as the trigger element is located in a range that can be sensed by the sensing element in the normal state.

For example, the trigger element may be, for example, a near field sensor chip (NFC), and the sensing element may be a sensor that can sense the near field sensor chip. Therefore, when the trigger element is within a certain range of the sensor, the sensor can sense the presence of the trigger element. And when a dangerous state occurs, for example when a skier falls, the near-field sensor chip is far away from the sensor, so that the sensor cannot sense the near-field sensor chip, thereby generating a trigger signal to trigger the inflating device.

The sensing element or sensor may transmit the trigger signal to the controller of the inflating device 100 in a wired or wireless manner. In the case of a wired connection, the sensing element 220 may be connected with the controller of the inflating device via a wire (not shown) embedded in the anti-collision suit 1, and sends a trigger signal to the controller of the inflating device. And in the case of a wireless connection, the sensing element includes, for example, a wireless transmitter and the controller of the inflating device includes a wireless receiver so that the trigger signal is wirelessly received from the sensing element.

Now the inflating device 100 according to a preferable embodiment of the present invention will be explained with reference to FIGS. 2 to 7. The inflating devices are respectively installed in the left and right shoulders of the anti-collision suit, and the inflating devices arranged on the left and right shoulders are arranged in such a way that they are mirror images of each other. Therefore, only one of the inflating devices will be described below.

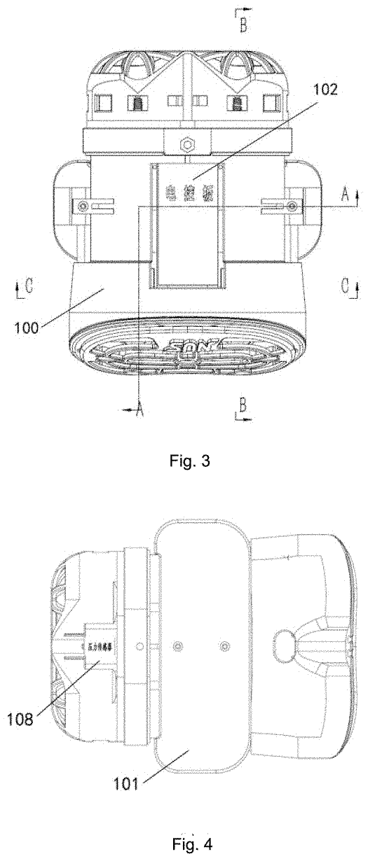

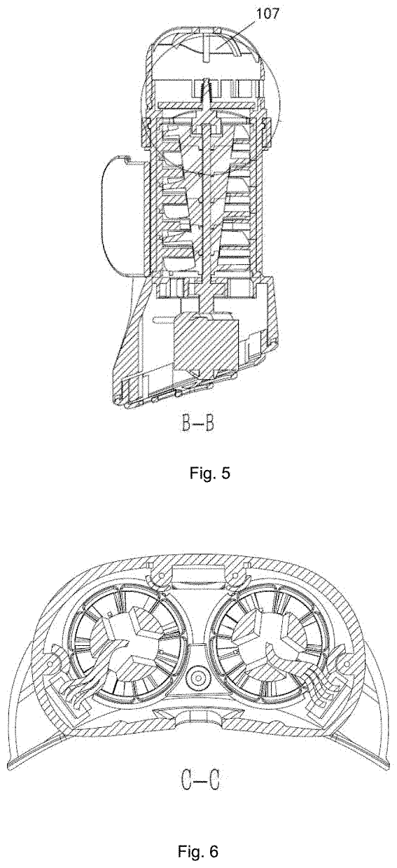

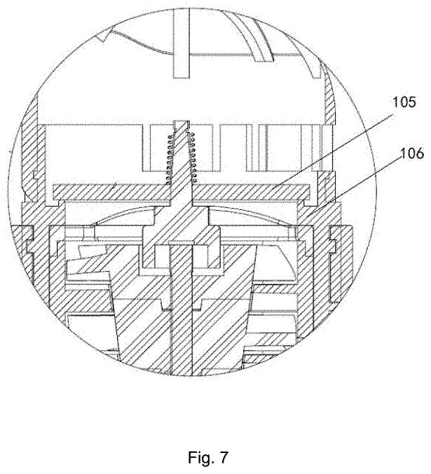

FIG. 2 is an exploded and perspective view of the inflating device, FIG. 3 is a top view of the inflating device 100, FIG. 4 is a bottom view of the inflating device 100, FIG. 5 is a cross-sectional view along B-B in FIG. 3, FIG. 6 is a cross-sectional view along C-C in FIG. 3, and FIG. 7 is an enlarged view of the circle in FIG. 5. In addition, in the following description, for the sake of convenience, the directional terms are defined when the skier wears the anti-collision suit. For example, “top” refers to the direction facing the sky when the skier is standing, and “bottom” refers to the direction opposite to the top; exterior or outer end refers to the side or end facing away from the skier's body, and the interior or inner end refers to the side or end facing the skier's body. The front side or front end refers to a side or an end facing the skier, and the rear side or rear end refers to a side or an end facing the back of the skier.

As shown in FIGS. 2 to 7, the inflating device 100 includes a housing 101, which is usually made of plastic. And the housing is formed in such a way that its bottom surface conforms to the shape of the shoulder of the human body, so that the inflating device 100 being arranged in the shoulder of the anti-collision suit will not cause any discomfort to the wearer. Of course, the present invention is not limited to this, and the inflating device 100 may also be arranged in any other positions as long as it is convenient and suitable.

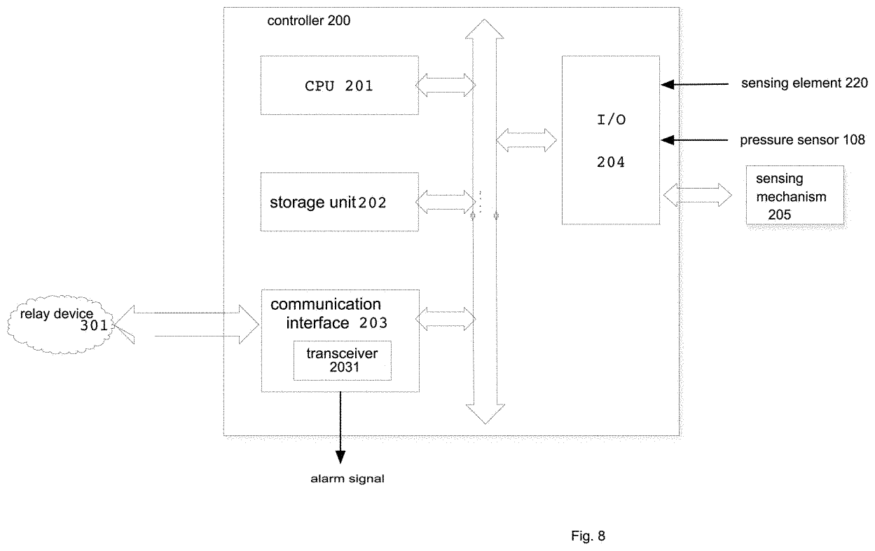

The anti-collision suit 1 also includes a controller 200. The controller 200 can be arranged on the top surface of the housing 101 of the inflating device 100 to form an assembly with the inflating device 100. The controller may control the activation of the inflating device 100 as desired to inflate the anti-collision suit 1. The controller 200 will be described in detail with reference to FIG. 8 later.

The housing 101 is provided with a motor 103 and a fan 104 fixed on the output shaft of the motor. As shown in the figure, in this embodiment, each inflating device is provided with two motors 103 and two fans 104 in parallel, so that the airbag can be quickly inflated within a very short time period, for example, 0.1 second to 1 second. However, the present invention is not limited to the number of motors and fans. As long as the airbag can be inflated within a predetermined time period, one motor and fan or more than two motors or multi-stage compression fans can also be used.

In one embodiment, the motor may be a high-speed DC motor. In addition, as shown in the figure, multi-stage fans are axially arranged on the output shaft of each motor, which is shown as 6-stage fans. These fans may be axial fans, but may also be centrifugal fans or mixed-flow fans as long as the fans can deliver enough flow and air pressure.

The outer end of the housing 101 includes a grid, which may be exposed to the outside, or be wrapped in the anti-collision suit and exposed when needed. The inner end of the housing 101 includes an air outlet 107 which communicates with the airbags of the anti-collision suit so as to inflate the airbags.

A check valve is also provided between the air outlet of the housing 101 and the fans. The check valve only allows the gas to enter the airbag via the inflating device, but does not allow the gas to leak from the airbags through the inflating device. In this embodiment, the check valve is composed of a non-return rubber sheet 105 arranged in the housing. When the inflating device is operating, the pressure of the air from the fan pushes the non-return rubber sheet 105 away, thereby inflating the airbags. When the motor of the inflating device 100 stops operating, the air pressure in the airbags presses the non-return rubber sheet 105 against the valve seat 106 formed in the housing, thereby preventing air from leaking via the housing of the inflating device 100.

An air pressure sensor 108 is also provided in the housing 101 of the inflating device 100 to sense the air pressure of the airbags. In addition, when the air pressure sensor 108 senses that the air pressure of the airbags reaches a predetermined threshold, the inflating device 100 stops inflating. It is advantageous to sense the air pressure at which the airbags are inflated by the air pressure sensor 108 and thus to control the inflating device, so as to ensure that the airbags are filled with sufficient air. This is even more beneficial for operation at different altitudes. In addition, due to the use of the anti-collision suit, the power of the battery that supplies the motor of the inflating device 100 will decrease. Thus, if time was used as the criteria to control the inflating device, insufficient inflation may occur in the event that the battery power drops. By sensing the air pressure at which the airbags are actually filled, the inflation and expansion requirements can be met under various conditions. Of course, the users should be protected from the danger due to the excessive air pressure.

For example, a manual switch 240 may be provided on the anti-collision suit to manually control the inflating device, so as to manually control the operation of the inflating device to inflate the airbags. In addition, a deflation valve 250 is also provided on the anti-collision suit, so that the air in the anti-collision suit is released as needed for storage after the anti-collision suit is inflated.

As an example, the anti-collision suit may also be provided with sensors to measure the vital signs of the skier. For example, a sensor, such as a body temperature sensor or a heart rate sensor, is provided at the position of the heart to sense the skier's heartbeat and/or body temperature. And, for example, a blood pressure sensor is installed at the sleeve to measure the blood pressure and heartbeat of the skier. The controller receives these data representing the vital signs of the skier, and calculates various parameters of the skier based on these data, for example, the skier's calorie consumption, exercise intensity, etc. And these data can be read and displayed via the applications installed on the skier's smart phone, etc. In addition, when these vital signs reach a dangerous threshold, a warning is issued to the skier or an alarm is automatically issued to the rescue station. For example, when the skier's heartbeat exceeds a predetermined value, when the body temperature is lower than a predetermined value, or when the blood pressure is lower than a predetermined value, etc., alarm messages are issued in order according to the degree of danger.

A sensing mechanism 205 is also provided on the controller. The sensing mechanism 205 may include a geographic location sensor that senses the geographic information of the skier, such as GPS, Beidou, Galileo system sensors, etc., to sense and record the skier's position. The location information can be read via the applications of the skier's smart phone, and the skier's footprints can be recorded. In addition, when an alarm message is issued, the location of the skier is also included and transmitted to a nearby rescue station so that the rescuer can quickly locate the skier.

Alternatively, the controller may perform an assessment based on the data representing the vital signs of the skier, and divide the skier's current status into urgent state, dangerous state and normal state. The controller may also take different measures for different states. For example, in the case that it is assigned an urgent state, the controller automatically sends out an alert message to the rescue station. While in a dangerous state, the controller first reminds the skier, and if the state continues without improvement, the state will be upgraded to an urgent state and automatically sends out an alarm message for help.

The anti-collision suit of the present invention also includes an active protection system (not shown). For example, radars are provided on a plurality of positions on the housing of the inflating device. The radars can detect surrounding obstacles around the skier in real time. When an obstacle is detected or when it is detected that the other skiers or objects are approaching at a high speed, the inflating device is automatically triggered to inflate the airbags, so as to prevent the skiers from high-speed impacts.

The controller 200 used in this anti-collision unit 1 is described in detail with reference to FIG. 8. The controller 200 may also be referred to as a computer, and may include a central processing unit (CPU, here also referred to as a “processor” and a “computer processor”) 201, which may be a single-core or multi-core processor, or multiple processors used for parallel processing. The controller 200 also includes a memory or storage unit 202 (for example, random access memory, read-only memory, flash memory), a communication interface 203 (for example, a network adaptor) for communicating with one or more other systems, and an input/output interface 204, such as cache, other memory, data storage and/or electronic display adaptor. The storage unit 202, the communication interface 203, and the input/output interface 204 communicate with the CPU 201 through a bus. The storage unit 202 may be a data storage unit (or a data storage library) for storing data and programs to be executed by the CPU 201.

As shown in FIG. 8, the input/output interface 203 communicates with the sensing mechanism 205 to receive sensing data from the sensing mechanism 205. The sensing mechanism 205 may sense the condition of the skier wearing the anti-collision suit 1. For example, the sensing mechanism 205 includes one or more of the following sensors: a speed and/or acceleration sensor, which may sense the speed and/or acceleration of the skier; a tilt sensor, such as a gyroscope or a magnetic sensor, which may sense the skier's body posture; a geographic location sensor, such as a GPS sensor or a Beidou sensor, a Galileo system sensor, etc., to determine the location of the skier; a physiological sensor, which may sense the physiological signs of the skier wearing the anti-collision suit 1, such as blood pressure, heartbeat, body temperature, etc.; a proximity sensor, to sense the distance between the skier and surrounding obstacles or other skiers nearby; and an image sensor to image the scene around the skier. The sensing mechanism 205 may be integrated with the controller 200, or may be a separate component and connected with the controller 200 via an interface circuit.

The input/output interface 230 of the controller 200 may also receive the trigger signal from the sensing element 220 of the anti-collision suit. Once the skier is in danger and loses the ski pole or the ski pole is detached, the sensor receives the trigger signal from the sensing element 220, thereby triggering the inflating device 100 to inflate the anti-collision suit 1. In the case that the sensing element 200 communicates with the controller 200 in a wireless manner to send a trigger signal to the controller 200, the input/output interface 230 includes a corresponding receiver to receive the trigger signal sent by the sensing element 220 according to a predetermined protocol, such as wifi, Bluetooth, zigbee, etc. In the case that the sensing element 220 communicates with the controller 200 in a wired manner, the input/output interface 230 of the controller 200 may include pins connected with the sensing element 220.

The communication interface 203 includes, for example, a transceiver 2031. The transceiver 2031 can transmit a danger signal under the control of the processor. The danger signal is, for example, a signal indicating that the skier is in danger or out of control. And the transceiver 2031 may receive a predetermined danger trigger signal. When the controller 200 receives the predetermined danger trigger signal via the transceiver 2031, the inflating device 100 may be controlled to trigger the inflating device 100 to inflate the anti-collision suit 1.

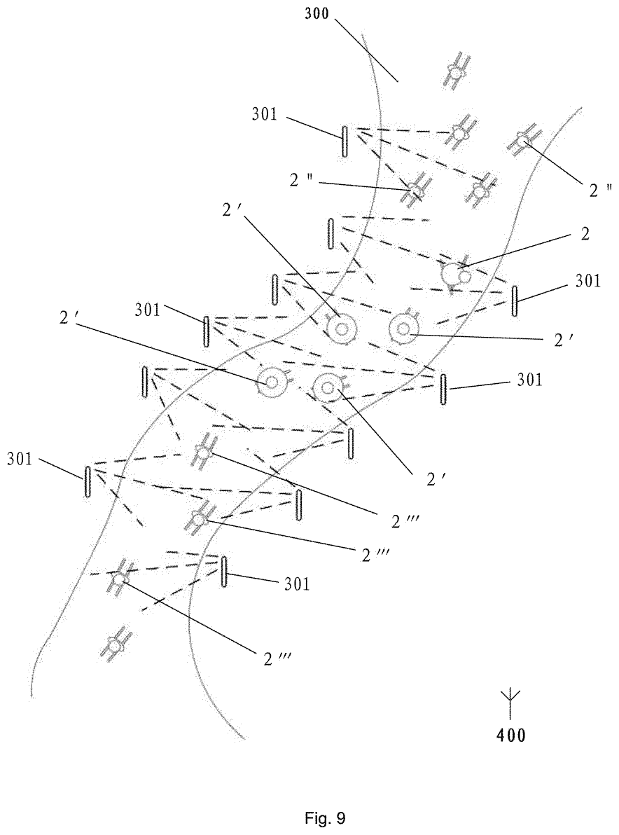

FIG. 9 is an embodiment showing a ski resort safety system according to the present invention. As shown in FIG. 9, the ski resort includes a ski trail 300. Relay devices 301 are preferably arranged at a certain distance on both sides of the ski trail 300, and the relay devices 301 may receive the danger signals from the anti-collision suit of the skier 2 and transmit a danger trigger signal to the designated equipment according to the received signal.

Now the ski resort safety system according to the invention will be explained with reference to FIG. 9.

When the skier 2 is skiing while wearing the anti-collision unit 1, once the skier encounters a dangerous situation, for example the skier falls or the skier's ski pole is detached, the controller 200 immediately receives the trigger signal sent from the sensing element 220 of the anti-collision suit, thereby sensing the dangerous situation and triggering the inflating device 100 to inflate the anti-collision suit 1. This dangerous situation includes, for example, the distance between the skier and the surrounding obstacles is less than a predetermined threshold, other skiers are approaching dangerously, the heartbeat or body temperature of the skier is outside the normal range, the skier falls and does not return to the normal state from the fallen state within a predetermined time, it is confirmed that the skier is in a dangerous state by performing image recognition on the image obtained by the image sensor. At the same time, a danger signal is transmitted via the transceiver 2031 of the communication interface of the controller 200. The danger signal is received by the relay devices 301 installed along the trail of the ski resort, and is re-transmitted, for example, in the form of a danger trigger signal by means of automatic broadcasting (as shown by the dashed line in FIG. 3). Therefore, the controller 200 of the anti-collision suit 1 of other skiers 2′ within the predetermined range can receive the broadcasted danger trigger signal through its own communication interface 203, and trigger the respective inflating device 100. Thus the anti-collision suits 1 of the skiers within a certain range (also referred to the dangerous range) of the skier 2 (hereinafter referred to as the out-of-control skier 2) encountering the danger are inflated, even if another skier 2′ is hit by the out-of-control skier 2, it will not cause a dangerous situation. And it also warns the skiers in a dangerous area so they can actively respond.

As an example, the danger signal sent from the anti-collision suit 1 and the danger trigger signal sent from the relay devices 301 of the ski trail adopt different coding forms or formats, and the danger signal may include position information of the out-of-control skier 2. The position information may be obtained by geographic location sensors in the sensing mechanism 205 of the controller 200, such as GPS and Beidou, etc., And the danger trigger signal sent by the relay devices 301 may also include the position information of the out-of-control skier 2, so that the anti-collision suit of the skier 2′ below the out-of-control skier 2 and within a certain range (dangerous range) from the out-of-control skier 2 receives and interprets the danger trigger signal, and is triggered to inflate the anti-collision suit 1. Even if a skier 2″ above the out-of-control skier 2″ or a skier 2′″ far away from the out-of-control skier 2 receives the signal, it will not be triggered, and the inflation of the anti-collision suit may be carried out in such a way that the skier's anti-collision suit 1 receives a danger trigger signal from the relay devices 301, and compares the position information contained in the danger trigger signal with its own position information sensed by the own sensing mechanism. And the inflating device 100 of the anti-collision suit 1 is triggered to quickly inflate the anti-collision suit when the comparison shows that it is located below the location of the out-of-control skier and is within a certain range, and the inflating device 100 will not be triggered when the comparison shows that it is located above the location of the out-of-control skier and is at a distance beyond a predetermined threshold, as shown by the skier 2′″ in FIG. 9. The predetermined threshold of the distance may be in the range of 50 meters to 100 meters, but the present invention is not limited to this, and can be set according to the situation. For example, in areas where the trail is relatively steep or where the skier's speed is expected to be relatively high, the predetermined threshold may be selected to be relatively large. While in areas where the trail is relatively gentle or the speed of the skier is expected to be low, the predetermined threshold may be selected to be small. Thereby, the CPU 201 of the control device 200 may receive the position signal indicating the location of the skier and set the predetermined threshold according to the program stored in the storage device 203.

In addition, the sensing mechanism 205 may also include a speed sensor and/or an acceleration sensor to sense the speed and/or acceleration of the skier. And the danger signal includes the speed and/or acceleration information. The system is calculates the dangerous area based on the speed and/or acceleration information, and sends a trigger signal to the anti-collision suit in the affected area via the relay devices 301. When other skiers in that area receive the trigger signal, the CPU 201 of the controller 200 of those skier's anti-collision suits 1 may calculate and set the predetermined threshold according to the speed information of the out-of-control skier. Therefore, when the speed of the out-of-control skier is relatively fast, the predetermined threshold may be set to be relatively large, and when the speed of the out-of-control skier is relatively slow, the predetermined threshold may be set to be relatively small.

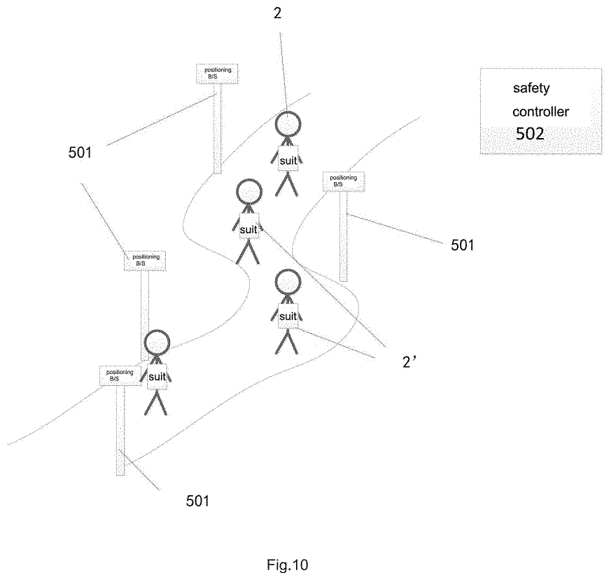

FIG. 10 shows another embodiment of the ski resort safety system according to the present invention. As shown in FIG. 10, positioning base stations 501 are distributed in the ski resort. The positioning base stations 501 communicate with the safety controller 502, and each positioning base station 401 may cover a certain range of ski resorts. After the skier 2 enters the ski resort, the controller 200 in the anti-collision suit 1 continuously sends the signal containing the position information of the skier 2 to a plurality of positioning base stations 501 arranged in the ski resort. Thus, for example, based on the principle similar to the base station of the mobile phones, the safety controller 502 determines the position and status of the skier 2 according to which positioning base stations 501 can receive the position information signal transmitted by the skier 2, for example, the speed and acceleration of the skier 2.

When the skier 2 has a dangerous situation, for example, a situation as described above in which the ski poles of the skier are detached, the sensing element 240 of the anti-collision suit 1 transmits a trigger signal to the controller 200. And the controller 200 triggers the inflating device 100 to inflate the anti-collision suit 1, and at the same time the danger signal is transmitted to the positioning base station 501 covering the area where the out-of-control skier 2 is located.

After the positioning base station 501 receives the danger signal and sends the danger signal to the safety controller 502, the safety controller 502 calculates the dangerous range based on the previously determined information such as the speed and acceleration of the out-of-control skier 2 and controls the base station covering that dangerous range to send a danger trigger signal. The controllers 200 of the anti-collision suits 1 of the skiers 2′ in that dangerous range receives the danger trigger signal and triggers the respective inflating device 100 to inflate the anti-collision suits 1. The positioning base station 501 not covering the dangerous range will not transmit the danger trigger signal, so the inflating devices 100 of the anti-collision suits 1 of other skiers who are not in the dangerous area will not be triggered.

Therefore, when the skier wearing the anti-collision suit 1 is not on the ski trail, for example, in a cable car or other location, even if a certain anti-collision suit 1 sends out a trigger signal due to a misoperation, other nearby anti-collision suits 1 will not be triggered because there is no relay device 301 or safety controller 501 receives the signal and re-transmits it. As an option, a signal transmitting station 400 may be set up at a place where it is not desired for the anti-collision suit 1 to start, such as a restaurant, a cable car station, etc. The signal transmitting station 400 may send out a prohibition signal which is received by the control device of the anti-collision suit 1 via its communication interface. Therefore, even if the trigger signal is received as well at the same time, the inflating device 100 will not be triggered to inflate the anti-collision suit 1, thereby preventing the anti-collision suit 1 from being triggered by mistake at these locations.

Although the present disclosure has been described with respect to exemplary embodiments, those skilled in the art should understand that various changes and modifications can be made without departing from the spirit and scope of the present disclosure. Therefore, it should be understood that the above-mentioned embodiments are not limiting, but illustrative.

1. A safety system of a ski resort, the ski resort including a ski trail, and the safety system including:
a detection device, which detects a skier on the ski trail, and receives a danger signal issued by the skier's anti-collision suit when the skier is in a dangerous situation, wherein the danger signal contains geographic location information representing the location of the skier; and
a safety controller, the safety device transmitting a danger trigger signal according to the danger signal, so that the inflating devices of the anti-collision suit of other skiers in a dangerous area at a predetermined distance from the skier are triggered, in order to inflate the anti-collision suit.

2. The safety system of a ski resort according to claim 1, wherein the detection device includes relay devices which are arranged at a certain interval along the ski trail, wherein the relay devices receive the danger signal and forward it as a danger trigger signal.

3. The safety system of a ski resort according to claim 2, wherein the danger trigger signal includes geographic location information of the skier.

4. The safety system of a ski resort according to claim 3, wherein the skier's anti-collision suit includes a controller that receives data sensed by a sensing mechanism, and wherein the sensing mechanism includes a geographic location sensor configured to sense the geographic location information of the skier.

5. The safety system of a ski resort according to claim 4, wherein the sensing mechanism also includes one or more of the following sensors: a speed and/or acceleration sensor, wherein the acceleration sensor may sense the speed and/or acceleration of the skier; a tilt sensor, such as a gyroscope or a magnetic sensor, which may sense the skier's body posture; a physiological sensor, which may sense the physiological signs of the skier wearing the anti-collision suit; a proximity sensor, to sense the distance between the skier and surrounding obstacles or other skiers nearby; and an image sensor to image the scene around the skier.

6. The safety system of a ski resort according to claim 4, wherein the controller also receives information to determine whether the ski poles are held by the skier.

7. The safety system of a ski resort according to claim 5, wherein said dangerous situation includes one or more of the following: the distance between the skier and the surrounding obstacles is less than a predetermined threshold, the heartbeat or body temperature of the skier is outside the normal range, and the skier falls and does not return to the normal state from the fallen state within a predetermined time.

8. The safety system of a ski resort according to claim 6, wherein the dangerous conditions include the ski poles not being held by the skier.

9. The safety system of a ski resort according to claim 7, wherein the danger signal and the danger trigger signal adopt different coding formats.

10. The safety system of a ski resort according to claim 9, wherein the controller is configured to compare the position information contained in the trigger signal with its own position information sensed by the sensing mechanism to determine whether it is located in the dangerous area, and triggers the inflating device to inflate the anti-collision suit when it is in the dangerous area.

11. The safety system of a ski resort according to claim 10, wherein the predetermined distance may vary according to the location of the skier or the speed and/or acceleration of the skier.

12. The safety system of a ski resort according to claim 1, wherein the detection device includes a plurality of positioning base stations, each of which respectively covers a predetermined area of a ski resort, and receives position information signal sent by a skier's anti-collision suit located in the predetermined area to determine the location information and motion status information of the skier;
the safety controller determines the dangerous area according to the position information and the motion state information of the skier who sent the danger signal, and makes the positioning base station covering the dangerous area transmit the dangerous trigger signal; and
controllers of the anti-collision suits of the skiers located in the dangerous area receives the trigger signal and triggers the inflating device to inflate the anti-collision suits.

13. The safety system of a ski resort according to claim 1, wherein it also includes a prohibition signal transmitting station which is arranged at a location where the anti-collision suit is not expected to be triggered, so as to prevent the anti-collision suit from being triggered at that location.

14. A method to ensure the safety of skiers, including:
receiving a danger signal sent by a first skier in a dangerous or out-of-control state; and
making the anti-collision suit of a second skier in a dangerous area at a predetermined distance from the first skier be inflated.

15. The method of claim 14, wherein the danger signal includes position information representing the geographic location of the first skier;
and wherein the predetermined distance is determined according to the position information and/or the speed/acceleration information of the first skier.

16. The method of claim 15, wherein the receiving step comprises using a relay device near the ski trail to receive the danger signal; and wherein
the making step includes the relay device sending out a danger trigger signal in a format different from the danger signal, the danger trigger signal containing the position information of the first skier and/or the speed/acceleration information of the first skier.

17. The method according to claim 16, wherein the making step includes the controller of the second skier's anti-collision suit receiving the danger trigger information, calculating the dangerous area based on the position information and/or speed/acceleration information contained in the danger trigger information, and determining whether the second skier is in the dangerous area according to the information representing the geographic position of the second skier.

18. The method according to claim 14, further comprising a positioning step in which a plurality of positioning base stations distributed in the ski resort receive positioning signals of the first skier to determine the position and motion status of the first skier, wherein the plurality of positioning base stations are distributed to cover different predetermined areas of the ski resort.

19. The method of claim 18, wherein the making step includes a safety controller in communication with a positioning base station receiving the danger signal, and calculating a dangerous area according to the danger signal, the position and the motion status information of the first skier, and prompting the positioning base station covering the dangerous area to send a danger trigger signal.

20. The method according to claim 14, wherein the dangerous or out-of-control state is determined by detecting the detachment of ski poles from the skier.
